(19) United States
(12) Patent Application Publication
(10) Pub. No.: US 2026/0339376 A1
(43) Pub. Date: Oct. 29, 2026

(54) PEDAL DEVICE

(71) Applicant: BOGE ELASTMETALL GMBH, Damme (DE)

(72) Inventors: Slawomir Bakaus, Bad Honnef (DE); Alexander HESSLING, Ruppichteroth (DE)

(21) Appl. No.: 19/124,141

(22) PCT Filed: Oct. 7, 2023
(86) PCT No.: PCT/EP2023/077810

§ 371 Date: Apr. 24, 2025

(30) Foreign Application Priority Data
Oct. 27, 2022 (DE) 10 2022 128 590.1

(51) Int. Cl. G05G 1/42; F16F 1/02; G05G 1/38; G05G 5/05

(52) U.S. Cl. CPC G05G 1/42; F16F 1/025; G05G 1/38; G05G 5/05

(57) ABSTRACT

Pedal device with a housing (2), a pedal (3), a spring means (4) connected to the housing (2) and to the pedal (3), and counter to the spring force of which the pedal (3) can be moved in an axial direction (x) relative to the housing (2), and a position detection device (5) which can detect a current axial position of the pedal (3) and can provide at least one position signal(S) that characterises this position, wherein the spring means (4) comprises one or more flat springs (9, 10), which are oriented transversely to the axial direction (x), and penetrated by the pedal (3) and resiliently supporting this on the housing (2) in the axial direction (x).

The invention relates to a pedal device with a housing, a pedal, a spring means connected to the housing and to the pedal, and counter to the spring force of which the pedal can be moved in an axial direction relative to the housing, and a position detection device which can detect a current axial position of the pedal, in particular relative to the housing, and can provide at least one position signal characterising this position.

DE 198 36 691 A1 discloses a pedal device for electrically actuated motor vehicle brakes, with a pedal body which can be moved in the actuation direction in translational motion, which is under the force of a spring counteracting the actuation direction as a return means, which preferably has a linear characteristic curve. The pedal body has an attachment means which converts at least one linearly increasing actuation travel increment into progressively increasing spring travel increments and imparts the travel increment to the adjacent spring, wherein a cam with a defined, non-linear cam profile is provided as an attachment means. At the foot end, the pedal body comprises a thickened cap to which a shaft connects, the end of which shaft is impinged upon by a return spring.

The disadvantage of this solution is the long actuation path, which is not functionally required in a brake-by-wire system, but generally serves to simulate the actuation behaviour of a hydraulic brake system. There is also a relatively high level of friction.

On this basis, the invention is based in particular on the object of creating a low-friction pedal device with a short actuation path.

According to the invention, this object is achieved with a pedal device according to claim 1. Preferred developments of the invention are given in the dependent claims and in the following description.

A pedal device comprising a housing, a pedal, a spring means connected to the housing and to the pedal, counter to the spring force of which the pedal can be moved in an axial direction relative to the housing, and a position detection device which can detect a current axial position of the pedal, in particular relative to the housing, and can provide at least one position signal characterising this position, is further developed according to the invention in particular by that the spring means comprises one or more, particularly flat, flat springs oriented transversely to the axial direction, penetrated by the pedal and supporting this in an axial direction by springs on the housing.

A comparatively short pedal travel can be achieved with the spring means according to the invention, so that the pedal device can also be relatively short overall. In particular, the pedal travel is only a few millimetres. For example, the particularly maximum and/or free spring travel of the spring means and/or the pedal travel is 3 mm, 5 mm or 3 mm to 5 mm.

A preferably axial position of the pedal that is set when the pedal device is not actuated is specifically referred to as the pedal rest position. In particular, the pedal can be moved counter to the spring force of the spring means, starting from the or a pedal rest position in the axial direction relative to the housing.

Advantageously, the spring means is elastically deformable in the axial direction, in particular by an axial actuation of the pedal.

Preferably, the current axial position of the pedal relative to the housing can be detected by means of the position detection device. The position signal characterises in particular this position of the pedal and/or a current axial stroke of the pedal with respect to the or a pedal rest position. Preferably, the position signal is an electrical signal.

A longitudinal axis running in an axial direction is preferably assigned to the pedal device. In particular, the longitudinal axis runs centrally through the pedal and/or centrally through the spring means and/or centrally through the housing.

Preferably, an axial actuation force lying on the longitudinal axis and acting on the pedal does not lead to any torque acting on the pedal, in particular with regard to the housing. One or any direction transverse to the axial direction and/or transverse to the longitudinal axis is in particular referred to as the radial direction. A direction running around the longitudinal axis is preferably referred to as the circumferential direction.

According to one embodiment, the pedal has an actuation section, preferably arranged outside the housing, in particular on the end face, and a preferably rod-shaped guide section, extending away from the actuation section, in particular in the axial direction. Preferably, each flat spring is penetrated by the guide section. In particular, each flat spring is penetrated by the pedal by being penetrated by the guide section of the pedal. Preferably, the guide section runs in an axial direction, preferably straight. In particular, the longitudinal axis runs centrally through the guide section. The actuation section is made of plastic and/or of metal, for example. In particular, the actuation section forms a rigid body. The guide section is made of plastic and/or metal, for example. In particular, the guide section forms a rigid body. For example, the guide section is, in particular at least in some regions, cylindrical and/or the guide section has, for example, a cylindrical outer circumferential surface. Advantageously, the actuation section is rigidly connected to the guide section.

The actuation section, in particular at least in some regions, preferably has larger dimensions transverse to the axial direction than the guide section. The actuation section, in particular at least in some regions, is preferably plate-shaped. For example, the actuation section is or comprises a pedal plate. Advantageously, the actuation section and/or the pedal plate is provided at one, preferably free, end of the pedal, in particular facing away from the housing. In particular, a pedal cap, preferably consisting of an elastomer, is located on the actuation section and/or the pedal plate. The pedal cap advantageously covers a side or end face of the actuation section and/or the pedal plate facing away from the housing and/or the guide section. The pedal is made of plastic and/or metal, for example. In particular, the pedal forms a rigid body.

The housing preferably has an axial end region on the pedal side and/or actuation section side, in which a pedal through-hole in particular is provided through which the pedal and/or the guide section extends, preferably into the housing. In particular, on its pedal-side and/or actuation section-side axial end region, the housing has a housing cover limiting the pedal through-hole. Preferably, the pedal cap grips the actuation section and/or the pedal plate with a buffer region which is arranged, in particular in the axial direction, between the actuation section or the pedal plate and the pedal-side or actuation section-side axial end region or the housing cover. Advantageously, the buffer region extends around the guide section, and/or the buffer region has, for example, several buffer region sections arranged around the guide section. The buffer region serves in particular as an end stop and/or to support the pedal if a torque acts on it, which can occur in particular when the pedal is actuated asymmetrically, so that tilting of the pedal can be avoided by the buffer region, for example. Alternatively, a buffer serving as an end stop can also be provided, for example, at an axial end of the guide section facing away from the actuation section and/or at a housing base axially opposite this end.

Preferably, the pedal cap has a collar portion protruding in the direction of the housing and surrounding and/or surrounding the or a pedal-side and/or actuation-side axial end region of the housing. The collar section also serves, for example, to support the pedal when a torque and/or a lateral force acts on it.

The spring means is preferably arranged in the housing. Preferably, the pedal and/or the guide section can be moved by the spring means in an axial direction, in particular on or in the housing. For example, the movability of the pedal and/or the guide section, in particular by the spring means, is limited to only one dimension, preferably relative to the housing. This dimension is given or defined in particular by the axial direction and/or the longitudinal axis.

The number of flat springs is preferably two or at least two. In particular, each flat spring is planar. Preferably, the flat springs are of identical design. Advantageously, each flat spring lies or runs, in particular in the non-tensioned state, in a flat spring plane that is preferably oriented or runs perpendicular to the axial direction. Each flat spring is preferably made of metal, in particular spring steel. Alternatively, each flat spring is made of plastic, for example. Each flat spring preferably has a central through-hole through which the pedal and/or its guide section, in particular, extends.

In particular, each flat spring is penetrated by the pedal by the pedal and/or the guide section extending through its central through-hole. For example, each flat spring forms a spring washer.

Preferably, each flat spring has at least one outer flat spring region, in particular facing away from the pedal and/or the guide section and/or facing the housing, which is in particular a radially outer flat spring region. Preferably, each flat spring is fastened to or in the housing on the outer circumferential side and/or with its outer flat spring region. Preferably, each flat spring has at least one inner flat spring region, in particular facing the pedal and/or the guide section and/or facing away from the housing, which is in particular a radially inner flat spring region. Preferably, each flat spring is attached to the pedal and/or the guide section on the inner circumferential side and/or with its inner flat spring region. For example, the inner flat spring region of each flat spring is penetrated by the pedal and/or the guide section.

The flat springs are preferably connected in parallel. Preferably, the pedal and/or the guide section is connected, in particular in a resilient manner, to the housing via the or a parallel connection of the flat springs. Advantageously, the pedal and/or the guide section can be moved counter to the spring force of the or a parallel connection of the flat springs, in particular starting from the or a pedal rest position, in an axial direction relative to the housing.

Preferably, the flat springs are arranged one behind the other in the axial direction and at a distance from one another. Thus, in particular, axial guidance of the pedal and/or the guide section can be realised by the spring means. Preferably, each flat spring has several spring bars, in particular three or at least three, preferably in the circumferential direction, in particular at least in some regions, spaced apart from each other and/or separated, which are preferably evenly distributed in particular around the pedal and/or the guide section. Advantageously, the spring bars of each flat spring extend or run, in particular transverse to the axial direction, between the pedal or guide section and the housing and/or from the pedal or guide section to the housing. The spring bars are also referred to as spring leaves, for example. In particular, the spring bars of each flat spring extend or run in their respective flat spring plane. Preferably, the pedal and/or the guide section is resiliently supported on the housing by means of or with the interposition of the spring bars, preferably at a, in particular radial, distance from the pedal and/or the guide section, in particular in the axial direction. As a result, for example, the pedal is resiliently supported on the housing, preferably in the axial direction, in particular by means of the flat springs.

Preferably, each spring bar has an outer and/or free spring bar end facing away from the pedal and/or the guide section and/or facing the housing, which is in particular a radially outer spring bar end. In particular, the outer flat spring region of each flat spring comprises its outer and/or free spring bar ends. For example, each flat spring is attached to or in the housing with its outer and/or free spring bar ends. Advantageously, each spring bar has an inner spring bar end facing in particular the pedal and/or the guide section and/or facing away from the housing, which is in particular a radially inner spring bar end. In particular, the inner flat spring region of each flat spring comprises its inner spring bar ends. For example, each flat spring is attached to the pedal and/or the guide section with its inner spring bar ends.

Preferably, several, for example three or at least three, axially continuous mounting holes are provided in each flat spring. Preferably, one of the mounting holes is provided in each outer and/or free spring bar end of each flat spring. Advantageously, several, for example three or at least three, mounting elements are provided which in particular penetrate or engage in the mounting holes. Preferably, the number of mounting elements corresponds to the number of mounting holes per flat spring. Preferably, the spring means is fastened to the housing by means of the mounting elements. In particular, the spring means is fastened to a housing wall of the housing by means of the mounting elements. Each mounting element is, in particular, pin-shaped and/or bolt-shaped and/or screw-shaped.

Preferably, one or more spacer elements are arranged between two adjacent flat springs by means of which the flat springs are held at an axial distance from each other. Preferably, one or more, in particular additional spacer elements are arranged between the spring means and the housing or the or a housing wall of the housing, by means of which the spring means is held at an axial distance from the housing and/or the housing wall. Each spacer element is in particular formed as a sleeve and preferably pushed onto one of the mounting elements. In particular, each spacer element formed as a sleeve is referred to as a spacer sleeve. Preferably, the spacer sleeves in particular each have a larger diameter and/or larger dimensions transverse to the axial direction than the respective mounting holes. The housing wall is, for example, the or a housing cover or the or a housing base.

Preferably, each flat spring has an outer frame, in particular rigidly connected with its spring bars and/or with its outer and/or free spring bar ends. For example, the outer flat spring region of each flat spring comprises or forms its outer frame or vice versa. Preferably, the spring bars of each flat spring extend from their outer frame towards the pedal and/or guide section. The outer frame of each flat spring is, in particular, ring-shaped or a ring and/or is also referred to as an outer ring, for example. Preferably, each flat spring, in particular on its outer circumference and/or with its outer frame, is attached to the housing. Advantageously, each flat spring engages, in particular on its outer circumference and/or outer circumference side and/or with its outer flat spring region and/or with its outer and/or free spring web ends and/or with its outer frame, in one or at least one groove provided on the inner circumference of the housing, which is preferably a ring groove. Each flat spring and/or the outer frame of each flat spring and/or the outer flat spring region of each flat spring preferably has a round and/or circular outer circumferential contour.

Preferably, each flat spring has an inner frame, in particular rigidly connected with its spring bars and/or with its inner spring bar ends. For example, the inner flat spring region of each flat spring comprises or forms its inner frame or vice versa. In particular, the inner frame of each flat spring limits its central through-hole. Advantageously, the inner frame surrounds or rings the pedal and/or the guide section. In particular, the pedal and/or guide section extends through the inner frame. For example, the inner frame of each flat spring is penetrated by the pedal and/or the guide section. Preferably, the spring bars of each flat spring extend from their inner frame towards the housing and/or towards the respective outer frame. Advantageously, the spring bars are arranged around the inner frame, preferably evenly distributed. The inner frame of each flat spring is, in particular, ring-shaped or a ring and/or is also referred to as an inner ring, for example. Advantageously, each flat spring is seated firmly with its inner frame on or at the pedal and/or guide section, in particular penetrating this. Preferably, each flat spring, in particular on its inner circumference and/or with its inner frame, is attached to the pedal and/or the guide section. Advantageously, each flat spring engages, in particular on its inner circumference and/or inner circumference side and/or with its inner flat spring region and/or with its inner spring bar ends and/or with its inner frame, in one or at least one groove provided on the outer circumference of the pedal and/or the guide section, which groove is preferably a ring groove. Each flat spring and/or the inner frame of each flat spring and/or the inner flat spring region of each flat spring preferably has a round and/or circular inner circumferential contour.

Advantageously, each flat spring and/or the inner frame of each flat spring and/or the inner flat spring region of each flat spring is provided with one or more, preferably window-like, and in particular axial, openings. Such openings can be used to influence the stiffness of the flat springs, for example. Preferably, in the case of each flat spring, the outer and/or free spring bar end of each spring bar is facing away from its inner frame and/or its inner flat spring region.

The outer frame of each flat spring preferably surrounds or rings its inner frame, advantageously at a distance, which is in particular a radial distance. Preferably, the spring bars of each flat spring extend from its inner frame and/or its inner flat spring region and/or from the pedal and/or from the guide section to its outer frame and/or to the housing. For example, the spring bars of each flat spring extend from its inner frame and/or its inner flat spring region and/or from the pedal and/or from the guide section towards the housing.

Preferably, each spring bar or each spring bar of each flat spring, in particular within its flat spring plane, for example single or multiple, is or runs in a manner which is angled and/or bent and/or curved. Preferably, each spring bar or each spring bar of each flat spring, in particular within its flat spring plane, is or runs in a manner which is bent back and forth and/or S-shaped. In particular, a linear behaviour and/or a linear characteristic curve can be achieved with spring bars shaped in this way. Alternatively, for example, each spring bar or each spring bar of each flat spring, in particular within its flat spring plane, runs straight, preferably transversely to the axial direction. For example, straight spring bars such as these can be used to achieve a progressive behaviour and/or a progressive characteristic curve.

The housing is preferably cylindrical, in particular at least in some regions. For example, the housing is pot-shaped. The housing is, for example, made of plastic and/or metal. For example, the housing comprises a preferably cylindrical sleeve, which is in particular a metal sleeve. Preferably, each flat spring is seated on or in the sleeve of the housing. Advantageously, each flat spring, in particular on the outer circumferential side and/or with one or at least one or its outer flat spring region and/or with its outer and/or free spring bar ends, is fastened to or in the sleeve of the housing. In particular, the housing sleeve ensures that the flat springs are firmly seated permanently. Preferably, the pedal and/or the guide section, in particular at least in some regions, is arranged in the sleeve of the housing and/or immersed in the sleeve of the housing. Preferably, the sleeve of the housing rings the pedal and/or a section of the pedal and/or the flat springs. The aforementioned section is in particular the guide section. The housing sleeve is made of steel or aluminium, for example. Preferably, each flat spring is attached on its outer circumference and/or with its outer frame to the sleeve of the housing. In particular, each flat spring, advantageously on its outer circumference and/or outer circumference side and/or with one or at least one or its outer flat spring region and/or with its outer and/or free spring bar ends and/or with its outer frame, engages in one or at least one groove provided on the inner circumference of the sleeve of the housing, which groove is preferably a ring groove. The groove or grooves provided on the inner circumference of the sleeve of the housing are in particular the groove or grooves provided on the inner circumference of the housing. Advantageously, the housing, in particular in addition to the or its sleeve, comprises at least one, preferably other, housing region which in particular is made of plastic, wherein this housing region is preferably rigidly connected to the sleeve of the housing. Preferably, the housing region and/or the housing comprises several housing parts that are rigidly connected to one another, for example by fastening means. In particular, the housing forms a rigid body.

The position detection device, which is for example also referred to as a position sensor, preferably comprises at least one sensor, such as for example at least one Hall sensor and/or at least one inductive sensor. Preferably, the at least one sensor is provided on the housing and/or is fixed relative to this. For example, the position detection device comprises at least one magnet attached to the pedal and/or the guide section and at least one Hall sensor attached to the housing.

According to one development, a control device is provided, preferably connected to the position detection device, by means of which at least one, preferably operable and/or controllable, vehicle component can be controlled depending on the position signal. The vehicle component is or comprises, for example, a vehicle brake. The pedal is in particular a brake pedal. The control device comprises, for example, an analogue computer or a digital computer. The pedal device is preferably provided for a vehicle, which is in particular a motor vehicle.

The invention is described below based on preferred embodiments with reference to the drawings. In the drawings:

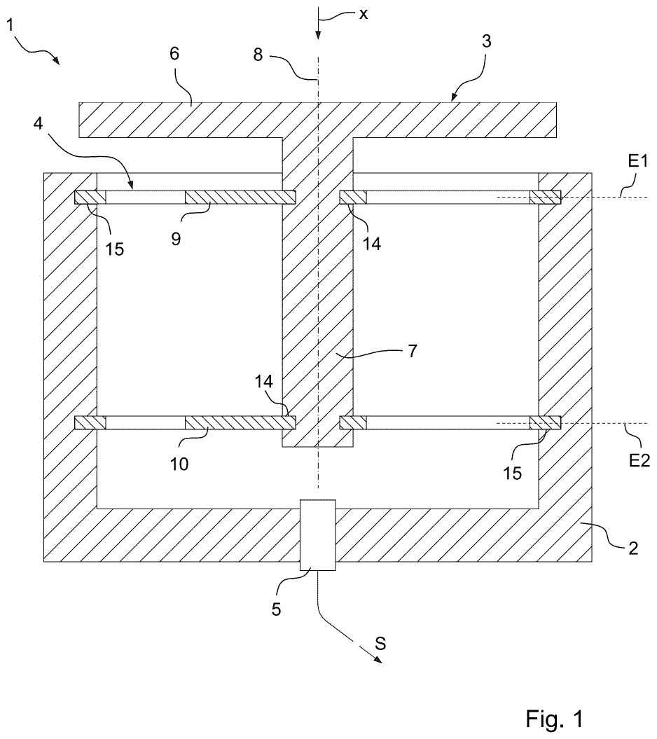

FIG. 1 is a schematic sectional view of a pedal device according to a first embodiment,

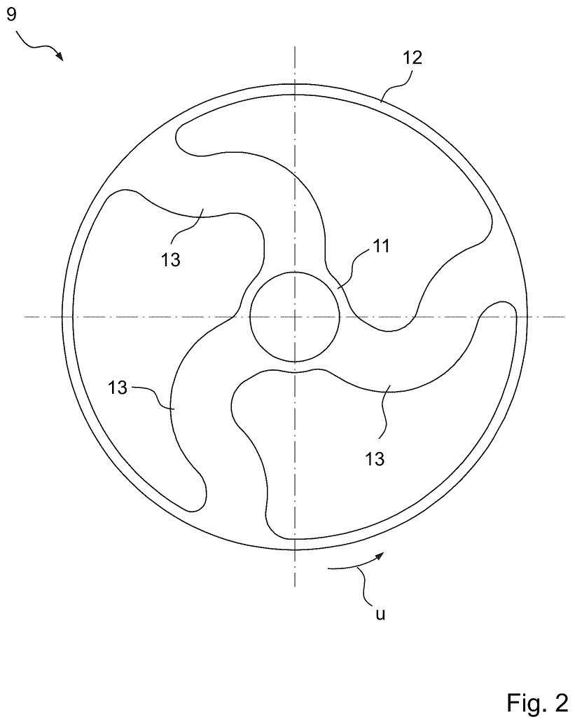

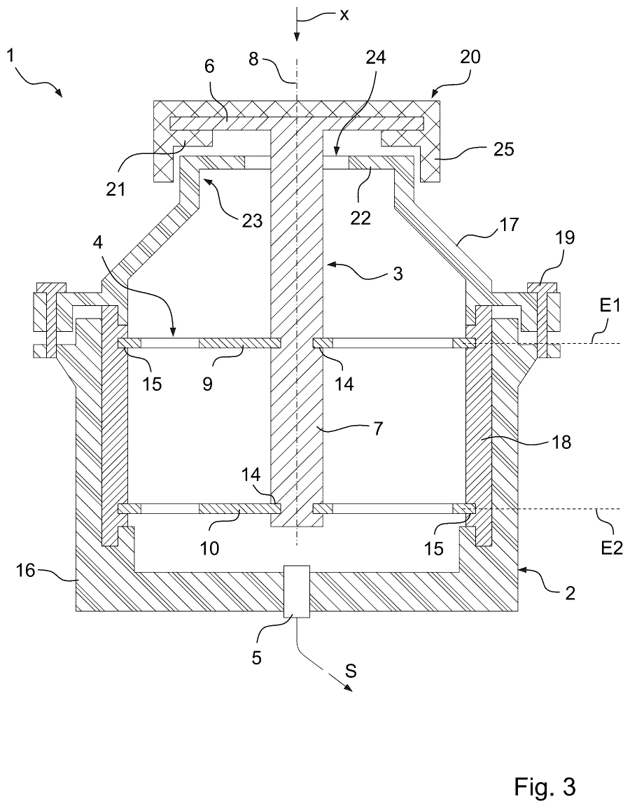

FIG. 2 is a top view of one of the flat springs as shown in FIG. 1 or FIG. 3,

FIG. 3 is a schematic sectional view of a pedal device according to a second embodiment,

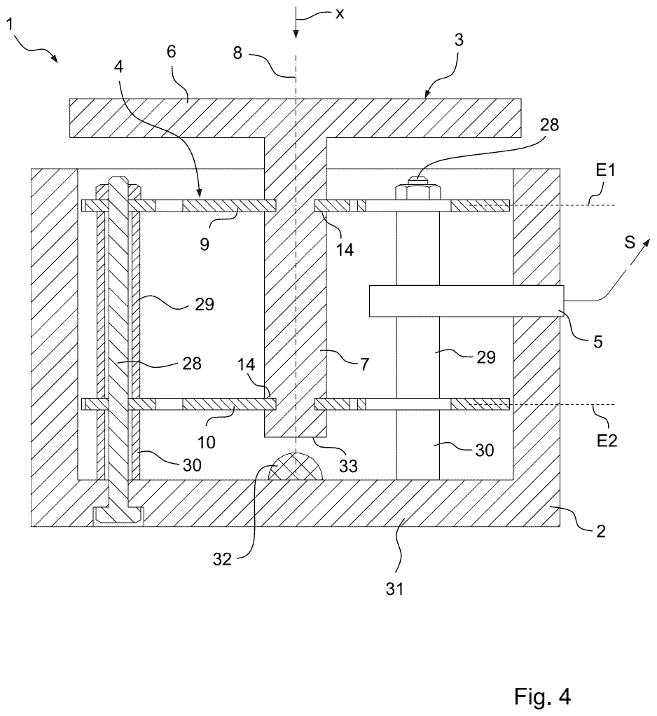

FIG. 4 is a schematic sectional view of a pedal device according to a third embodiment and

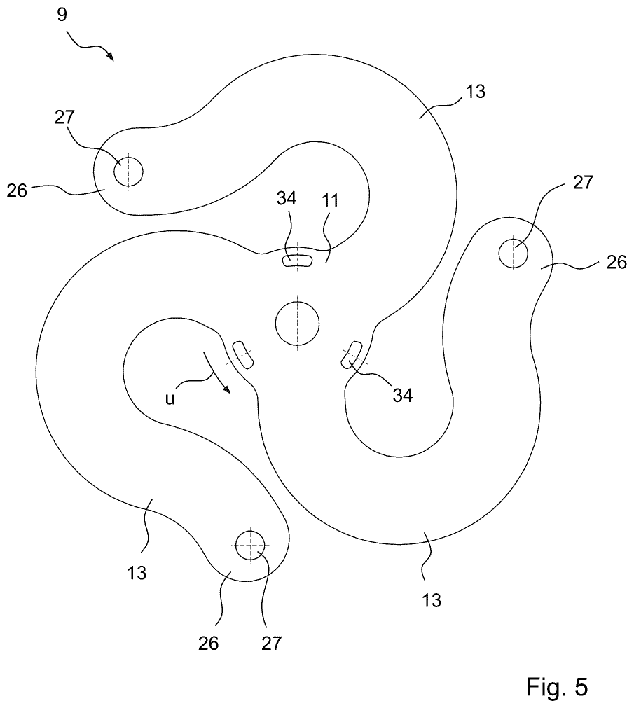

FIG. 5 is a top view of one of flat springs as shown in FIG. 4.

FIG. 1 shows a schematic sectional view of a pedal device 1 according to a first embodiment, which comprises a housing 2, a pedal 3, a spring means 4 connected to the housing 2 and to the pedal 3, counter to the spring force of which the pedal 3 can be moved in an axial direction x relative to the housing 2, and a position detection device 5 which can detect a current axial position of the pedal 3 relative to the housing 2 and can provide at least one position signal S characterising this position.

The pedal 3 has an actuation section 6 arranged outside the housing 2, which section is in particular plate-shaped, and a guide section 7 extending in the axial direction x away from this, which is in particular rod-shaped. Furthermore, a longitudinal axis 8 extending in the axial direction x, in particular running centrally through the guide section 7, is assigned to the pedal device 1. A direction running transversely to the longitudinal axis 8 is in particular referred to as a radial direction. Furthermore, a direction running around the longitudinal axis 8 is in particular referred to as a circumferential direction u.

The spring means 4 comprises several, in particular two, planar flat springs 9 and 10 oriented transversely to the axial direction x, penetrated by the pedal 3 and resiliently supporting this in an axial direction on the housing 2, which flat springs are arranged one after the other in the axial direction x and at a distance from each other. The flat springs 9 and 10 are preferably of identical design and each run in a flat spring plane, wherein the flat spring plane of the flat spring 9 is denoted by E1 and the flat spring plane of the flat spring 10 is denoted by E2. Each flat spring plane runs in particular transversely to the axial direction x.

A first of the flat springs 9 is shown in a top view in FIG. 2 and has an inner ring 11, an outer ring 12 surrounding the inner ring, and several, in particular three, spring bars 13 arranged around the inner ring 11, which extend from the inner ring 11 to the outer ring 12 and are rigidly connected both to the inner ring 11 and to the outer ring 12. In this case, the spring bars 13 are arranged in an evenly distributed manner around the inner ring 11 and are in particular S-shaped in each case. The flat spring 10 is preferably designed accordingly.

Each flat spring is seated firmly on the guide section 7 with its inner ring 11 and, for this purpose, preferably engages with its inner ring 11 in a ring groove 14 provided on the outer circumference of the guide section 7. Furthermore, each flat spring is fastened to the housing 2 with its outer ring 12 and, for this purpose, preferably engages with its outer ring 12 in a ring groove 15 provided on the inner circumference of the housing 2.

FIG. 3 shows a schematic sectional view of a pedal device 1 according to a second embodiment, wherein features identical or similar to the first embodiment are denoted by the same reference signs as in the first embodiment. The pedal device 1 according to the second embodiment has a housing 2, a pedal 3, a spring means 4 connected to the housing 2 and to the pedal 3, counter to the spring force of which the pedal 3 can be moved in an axial direction x relative to the housing 2, and a position detection device 5, which can detect a current axial position of the pedal 3 relative to the housing 2 and provide at least one position signal S characterising this position.

The pedal 3 has an end-side actuation section 6 arranged outside the housing 2, which section is in particular plate-shaped, and a guide section 7 extending in the axial direction x away from this, which section is in particular rod-shaped. Furthermore, a longitudinal axis 8 extending in the axial direction x, in particular running centrally through the guide section 7, is assigned to the pedal device 1. A direction running transversely to the longitudinal axis 8 is in particular referred to as a radial direction. Furthermore, a direction running around the longitudinal axis 8 is in particular referred to as a circumferential direction u.

The housing 2 comprises a first housing part 16 made of plastic, a second housing part 17 made of plastic and a metal sleeve 18 located in the first housing part 16. The two housing parts 16 and 17 are rigidly connected to each other via fastening means 19, such as screws, and fix the metal sleeve 18 between them.

The spring means 4 comprises several, in particular two, planar flat springs 9 and 10 oriented transversely to the axial direction x, penetrated by the pedal 3 and resiliently supporting this in an axial direction on the housing 2, which flat springs are arranged one after the other in the axial direction x and at a distance from each other. The flat springs 9 and 10 are seated in the metal sleeve 18 of the housing 2. The flat springs 9 and 10 are preferably of identical design and each run in a flat spring plane, wherein the flat spring plane of the flat spring 9 is denoted by E1 and the flat spring plane of the flat spring 10 is denoted by E2. Each flat spring plane runs in particular transversely to the axial direction x.

The flat springs according to the second embodiment are designed in accordance with the flat springs according to the first embodiment, so that reference is made in particular to FIG. 2 for the description of the flat springs.

The flat spring 9 is shown in a top view in FIG. 2 and has an inner ring 11, an outer ring 12 surrounding the inner ring, and several, in particular three, spring bars 13 arranged around the inner ring 11, which extend from the inner ring 11 to the outer ring 12 and are rigidly connected both to the inner ring 11 and to the outer ring 12. In this case, the spring bars 13 are arranged in an evenly distributed manner around the inner ring 11 and are in particular S-shaped in each case. The flat spring 10 is preferably designed accordingly.

Each flat spring is seated firmly on the guide section 7 with its inner ring 11 and, for this purpose, preferably engages with its inner ring 11 in a ring groove 14 provided on the outer circumference of the guide section 7. Furthermore, each flat spring is fastened with its outer ring 12 to the metal sleeve 18 of the housing 2 and, for this purpose, preferably engages with its outer ring 12 in a ring groove 15 provided on the inner circumference of the metal sleeve 18.

A pedal cap 20 is located on the actuation section 6, which cap covers a side of the actuation section 6 facing away from the housing 2 and preferably consists of an elastomer. Preferably, the pedal cap 20 grips underneath the actuation section 6 with a buffer region 21, which is arranged in the axial direction x between the actuation section 6 and a housing cover 22, which is provided on a pedal-side axial end region 23 of the housing 2 and delimits a pedal through-hole 24, through which the guide section 7 extends. Advantageously, the pedal cap 20 also has a collar section 25 protruding towards the housing 2 and surrounding the pedal-side axial end region 23 of the housing 2.

FIG. 4 shows a schematic sectional view of a pedal device 1 according to a third embodiment, wherein features identical or similar to the previous embodiments are denoted by the same reference signs as in the previous embodiments. The pedal device 1 according to the third embodiment has a housing 2, a pedal 3, a spring means 4 connected to the housing 2 and to the pedal 3, counter to the spring force of which the pedal 3 can be moved in an axial direction x relative to the housing 2, and a position detection device 5, which can detect a current axial position of the pedal 3 relative to the housing 2 and provide at least one position signal S characterising this position.

The pedal 3 has an end-side actuation section 6 arranged outside the housing 2, which section is in particular plate-shaped, and a guide section 7 extending in the axial direction x away from this, which section is in particular rod-shaped. Furthermore, a longitudinal axis 8 extending in the axial direction x, in particular running centrally through the guide section 7, is assigned to the pedal device 1. A direction running transversely to the longitudinal axis 8 is in particular referred to as a radial direction. Furthermore, a direction running around the longitudinal axis 8 is in particular referred to as a circumferential direction u.

The spring means 4 comprises several, in particular two, planar flat springs 9 and 10 oriented transversely to the axial direction x, penetrated by the pedal 3 and resiliently supporting this in an axial direction on the housing 2, which flat springs are arranged one after the other in the axial direction x and at a distance from each other. The flat springs 9 and 10 are preferably of identical design and each run in a flat spring plane, wherein the flat spring plane of the flat spring 9 is denoted by E1 and the flat spring plane of the flat spring 10 is denoted by E2. Each flat spring plane runs in particular transversely to the axial direction x.

The flat spring 9 is shown in a top view in FIG. 5 and has an inner ring 11 and several, in particular three, spring bars 13 arranged around the inner ring 11, which are rigidly connected to the inner ring 11 and extend from this towards the housing 2. In this case, the spring bars 13 are arranged in an evenly distributed manner around the inner ring 11 and are in particular S-shaped in each case. Furthermore, each spring bar 13 has a free spring bar end 26 facing away from the inner ring 11, in which in particular an axially continuous mounting hole 27 is provided. Furthermore, the inner ring 11 is preferably provided with a plurality of axial openings 34. The flat spring 10 is preferably designed accordingly.

Each flat spring is seated firmly on the guide section 7 with its inner ring 11 and, for this purpose, preferably engages with its inner ring 11 in a ring groove 14 provided on the outer circumference of the guide section 7. Moreover, several pin-shaped mounting elements 28 which penetrate the mounting holes 27 are provided, by means of which the spring means 4 is fastened to the housing 2. In this case, a spacer sleeve 29 is preferably pushed onto each mounting element 28, which sleeve is arranged between the two flat springs 9 and 10 and holds them at a distance from each other. Advantageously, an additional spacer sleeve 30 is pushed onto each mounting element 28, which sleeve is arranged between a housing base 31 and the lower flat spring 10 and holds this spring and therefore the spring means 4 at a distance from the housing base 31.

A buffer 32, preferably consisting of elastomer, is preferably provided on the housing base 31, which buffer is axially opposite an axial end 33 of the guide section 7 facing away from the actuation section 6 and serves in particular as an axial end stop for the pedal 3. Alternatively, however, the buffer 32 can also be provided for example at the axial end 33 of the guide section 7.

### LIST OF REFERENCE NUMERALS

1 Pedal device
2 Housing
3 Pedal
4 Spring means
5 Position detection device
6 Actuation section
7 Guide section
8 Longitudinal axis
9 Flat spring
10 Flat spring
11 Inner ring
12 Outer ring
13 Spring bar
14 Ring groove
15 Ring groove
16 First housing part
17 Second housing part
18 Metal sleeve
19 Fastening means
20 Pedal cap
21 Buffer region
22 Housing cover
23 Axial end region of the housing
24 Pedal through-hole
25 Collar section
26 Spring bar end
27 Mounting hole
28 Mounting element
29 Spacer sleeve
30 Spacer sleeve
31 Housing base
32 Buffer
33 Axial end
34 Opening
E1 Flat spring plane
E2 Flat spring plane
S Position signal
u Circumferential direction
X Axial direction

1. A pedal device having a housing, a pedal, a spring means connected to the housing and to the pedal, and counter to the spring force of the spring means, the pedal can be moved in an axial direction (x) relative to the housing, and a position detection device which can detect a current axial position of the pedal and can provide at least one position signal (S) that identifies this position, wherein the spring means comprises one or more flat springs, which are oriented transversely to the axial direction (x), and penetrated by the pedal and resiliently supporting this on the housing in the axial direction (x).

2. The pedal device according to claim 1 wherein the pedal further has an actuation section arranged outside the housing and has a guide section extending away from this actuation section in the axial direction (x), via which guide section each flat spring penetrated.

3. The device according to claim 2, further having a pedal cap seated on the actuation section, which pedal cap covers a side of the actuation section facing away from the housing and grips under it with a buffer region which is arranged between the actuation section and a pedal-side axial end region of the housing in the axial direction (x).

4. The pedal device according to claim 1 wherein the pedal is connected to the housing via a parallel arrangement of the flat springs.

5. The pedal device according to claim 1, wherein the flat springs are arranged one after the other in the axial direction (x) and at a distance from each other.

6. The pedal device of claim 1, wherein each flat spring has spring bars arranged around the pedal which spring bars resiliently support the pedal in the axial direction (x) on the housing.

7. The pedal device according to claim 6, wherein each flat spring has an inner ring rigidly connected to its spring bars and penetrated by the pedal by which inner ring the flat spring is fastened to the pedal.

8. The pedal device according to claim 7, wherein each flat spring has an outer ring rigidly connected to its spring bars and surrounding its inner ring by which outer ring the flat spring is fastened to the housing.

9. The pedal device according to claim 6, wherein each flat spring is fastened to the housing with outer ends of its spring bars.

10. The pedal device according to claim 6, wherein each spring bar is S-shaped.

11. The pedal device according to claim 1, wherein the housing comprises a metal sleeve surrounding a section of the pedal to which each flat spring is fastened with at least one outer flat spring region.
